(19) United States
(12) Patent Application Publication
(10) Pub. No.: US 2001/0042671 A1
(43) Pub. Date: Nov. 22, 2001

(54) Commodity price setting method and commodity price setting system in automatic vending machine

(76) Inventors: Kazuyasu Ushigome, Isesaki-shi (JP); Naoto Matsumoto, Maebashi-shi (JP)

Correspondence Address: BANNER & WITCOFF, 1001 G STREET N W, SUITE 1100, WASHINGTON, DC, 20001, US

(21) Appl. No.: 09/855,570

(22) Filed: May 16, 2001

(30) Foreign Application Priority Data
May 22, 2000 (JP) 2000-149657

(51) Int. Cl. G07F 7/04; G07F 9/08

(52) U.S. Cl. 194/206; 700/231; 194/215; 194/229

(57) ABSTRACT

To provide a commodity price setting method and a commodity price setting system in an automatic vending machine, which can reduce wrong setting of a commodity price and with which an operator can easily set and confirm a commodity price. Since a numerical value of a commodity price is formed by multiplying a minimum currency value in an inputting apparatus and this numerical value is inputted in a storage device, a set value can always be a multiple of a minimum currency value with a minimum unit of the set value as the minimum currency value. Therefore, a fraction less than the minimum currency value that cannot be used in the automatic vending machine is never set as a commodity price, and confusion and wrong operation such as a customer trying to insert an unusable currency can be surely prevented.

### BACKGROUND OF THE INVENTION

1. Field of the Invention

The present invention relates to a commodity price setting method and a commodity price setting system in an automatic vending machine for selling beverages contained in, for example, cans, bottles or PET bottles.

2. Description of the Related Art

Conventionally, in setting a commodity price in a memory of a main control apparatus in an automatic vending machine, an inputting operation is carried out by an operator to form a numerical value of a commodity price by ten-keys of a remote controller or an operating panel and transfer this numerical value to the memory. In addition, if a commodity price is changed, it is updated by rewriting a set value by the similar operation.

However, since a numerical value of a commodity price is inputted by ten-keys “0” to “9” of the operating panel in the above-mentioned setting operation, a minimum unit of a numerical value (a minimum variation of a numerical value) is “1”, thus it is likely that a price for a commodity, with the price of 80 cents, for example, is inadvertently set as 81 cents, 82 cents or the like.

In such a case, since a currency with a minimum amount among currencies allowed to be used in an automatic vending machine for selling a commodity of 80 cents is generally a 5-cent coin, if a commodity price is inadvertently set as, for example, 81 cents, there is a problem in that a customer may be confused or perform wrong operation of an automatic vending machine such as trying to insert 1-cent coin that is not allowed to be used.

The above-mentioned problem is particularly evident in setting a commodity price when an automatic vending machine is installed anew, a commodity price is changed, a currency discriminating device is replaced, or the like. In addition, there is also a problem in that a significant amount of time and labor is required for confirming whether a set value is correct or not.

Due to the reasons mentioned above, it is conventionally difficult to move an automatic vending machine from a country or a region to other countries or regions where different currencies are used, and regions where an automatic vending machine can be installed is limited.

### SUMMARY OF THE INVENTION

The present invention has been devised in view of the above-mentioned problems, and it is an object of the present invention to provide a commodity price setting method and a commodity price setting system in an automatic vending machine, which can reduce the possibility of inadvertently setting a commodity price and with which an operator can easily set and confirm a commodity price.

In a commodity price setting method of the present invention, when a commodity price is inputted in a storage device by an inputting apparatus in an automatic vending machine, the commodity price is formed by multiplying a value of a currency with a minimum amount among currencies that are usable in the automatic vending machine.

Thus, since a numerical value of a commodity price is formed by multiplying a minimum currency value (including the case in which a minimum currency value is multiplied by adding it sequentially) if the inputting apparatus and the numerical value is inputted in the storage device, a set value can always be a multiple of minimum currency value with a minimum unit of the set value as the minimum currency value. Therefore, a fraction less than the minimum currency value that is not usable is never set as a commodity price in the automatic vending machine, and confusion or wrong operation such as a customer trying to insert an unusable currency can be surely prevented.

In addition, in a commodity price setting system of the present invention is a commodity price setting system in an automatic vending machine provided with a storage device for storing a commodity price and an inputting apparatus for inputting a commodity price in the storage device, wherein the inputting apparatus forms a commodity price by multiplying a value of a currency with a minimum amount among currencies that are allowed to be used in the automatic vending machine.

Thus, as described above, since a numerical value of a commodity price is formed by multiplying a minimum currency value in the inputting apparatus and this numerical value is inputted in the storage device, a set value can always be a multiple of a minimum currency value.

In addition, the present invention of the above-mentioned configuration is provided with a currency discriminating device that can discriminate a type of a usable currency, a control device for obtaining the minimum currency value from the currency discriminating device and causing the storage device to store the minimum currency value, and notifying means that can notify an operator of the inputting apparatus of the minimum currency value stored in the storage device.

Thus, since a minimum currency value can be obtained by the control device from the currency discriminating device and saved in the storage device, and at the same time, the minimum currency value can be notified to an operator by the notifying means, the operator can promptly and accurately grasp the minimum currency value and can easily set a commodity price based on the minimum currency value at the time of, for example, setting an automatic vending machine anew.

Further, the currency discriminating device includes, in addition to a coin discriminating device and a paper currency discriminating device, an apparatus (contacting non-contacting) that can discriminate a credit card, a prepaid card, an electronic money IC card that are allowed to be used in an automatic vending machine, a commodity certificate, a gift certificate or the like to read or rewrite balance data and measurement held by these.

In addition, the present invention of the above-mentioned configuration is characterized in that the notifying means is a display.

Thus, an operator can promptly and accurately grasp a minimum currency value by an indication of the display.

In addition, the present invention of the above-mentioned configuration is characterized in that, in accordance with a change of a minimum currency value in the currency discriminating device, the control device updates a minimum currency value stored in the storage device to the changed minimum currency value and, at the same time, causes the notifying means to notify the updated minimum currency value.

Thus, even if a price of at least a part of commodities is changed to a price that is not a multiple of a minimum currency value at the time of replacement of a currency discriminating device accompanied by change of a minimum currency value, or the like, a commodity price can be easily changed based on the minimum currency value and whether or not a set value is correct can be easily confirmed with the minimum currency value as a minimum unit of the set value. Therefore, a commodity price can be easily set and confirmed, and an automatic vending machine can be easily moved from a country or a region to other countries or regions having different currencies depending on sales status or the like.

In addition, the present invention of the above-mentioned configuration is characterized in that the control device makes a commodity unavailable for sales, whose a commodity price is not a multiple of an updated minimum currency value any more as a minimum currency value is changed.

Thus, since sales of a commodity is stopped, whose a commodity price is not a multiple of an updated minimum currency value any more as a minimum currency value is changed, a commodity is never sold if a change cannot be returned due to change of a minimum currency value when the commodity is sold.

### BRIEF DESCRIPTION OF THE DRAWINGS

FIG. 1 is a front view of an automatic vending machine;

FIG. 2 is a block diagram of a commodity price setting system;

FIG. 3 is a flow chart from turn-on to setting operation of a commodity price; and

FIG. 4 is a flow chart from replacement of a coin discriminating device to changing operation of a commodity price.

### DESCRIPTION OF THE PREFERRED EMBODIMENTS

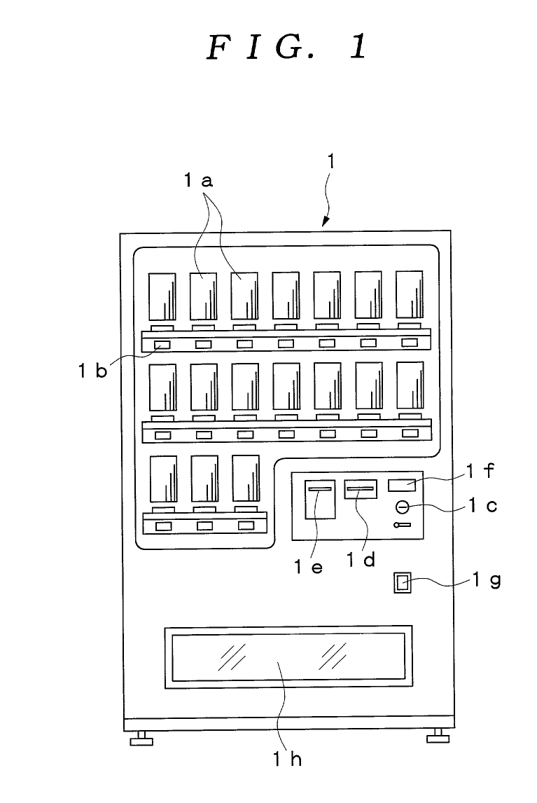

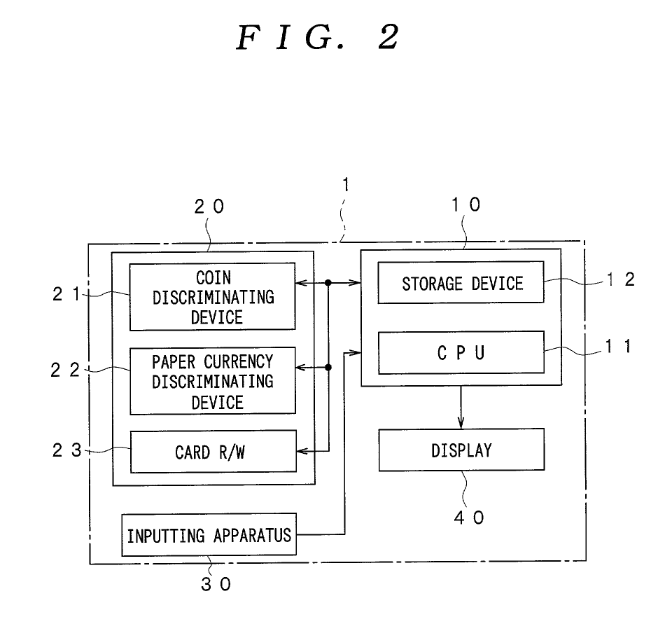

FIGS. 1 to 4 illustrate an embodiment of the present invention.

An automatic vending machine 1 shown in FIG. 1 is an example of an automatic vending machine to which a commodity price setting system of the present invention is applied. A plurality of commodity samples 1a, a plurality of commodity selection button switches 1b, a coin inserting slot 1c, a paper currency inserting slot id, a card inserting slot 1e, an amount display part if, a coin returning opening 1g and a commodity take-out opening 1h are provided on a front surface of the automatic vending machine 1.

The commodity price setting system is provided with a main control device 10 for controlling commodity selling operation or the like in the automatic vending machine 1, a currency discriminating device 20 for discriminating various currencies or the like to be inserted in the automatic vending machine 1, an inputting apparatus 30 such as a remote controller that is operated when an operator sets or changes a commodity price, and a display 40 as notifying means for displaying a minimum currency value to be described later to notify the operator of the minimum currency value. Further, the notifying means may be means for notifying an operator of a minimum currency value by wireless communication with a mobile terminal or the like carried by the operator.

The main control device 10 is provided with a CPU 11 as a control device, a storage device 12 consisting of an RAM and an ROM (not shown), and is connected to the currency discriminating device 20 such that various kinds of data can be transmitted and received.

The currency discriminating device 20 consists of a coin discriminating device 21 for discriminating a type of a coin that is usable in the automatic vending machine 1, a paper currency discriminating device 22 for discriminating a type of a usable paper currency, and a card R/W 23 for discriminating a usable card (a credit card or the like) and reading/writing of balance data held by the card.

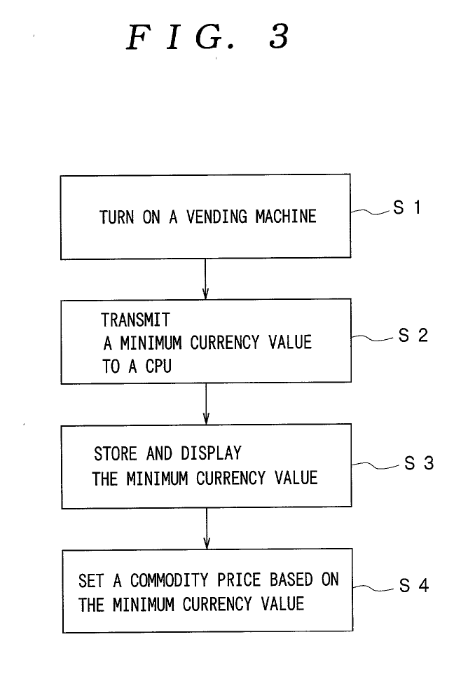

The coin discriminating device 21, the paper currency discriminating device 22 and the card R/W 23 are provided with a microcomputer, respectively. Information of various kinds of coins and paper currencies that are allowed to be used in the automatic vending machine 1 is set in advance in the coin discriminating device 21 and the paper currency discriminating device 22. A value of a currency with a minimum amount (hereinafter referred to as “minimum currency value”) among the set information of various coins and paper currencies is automatically transmitted from the currency discriminating device 20 to the CPU 11 (S2) by turning on the automatic vending machine 1 (S1) as shown in FIG. 3 when the automatic vending machine 1 is set anew. The CPU 11 causes the storage device 12 to store this minimum currency value data and, at the same time, causes the display 40 to display the minimum currency value data via a display driving circuit (not shown) (S3). Then, the operator forms a numerical value of a predetermined commodity price by multiplying the minimum currency value in the inputting apparatus 30 based on the minimum currency value displayed by the display 40, and transfers the numerical value to the storage device 12 via the CPU 11 (S4). Further, whether or not a set value is correct can be easily confirmed thereafter with the minimum currency value as a minimum unit.

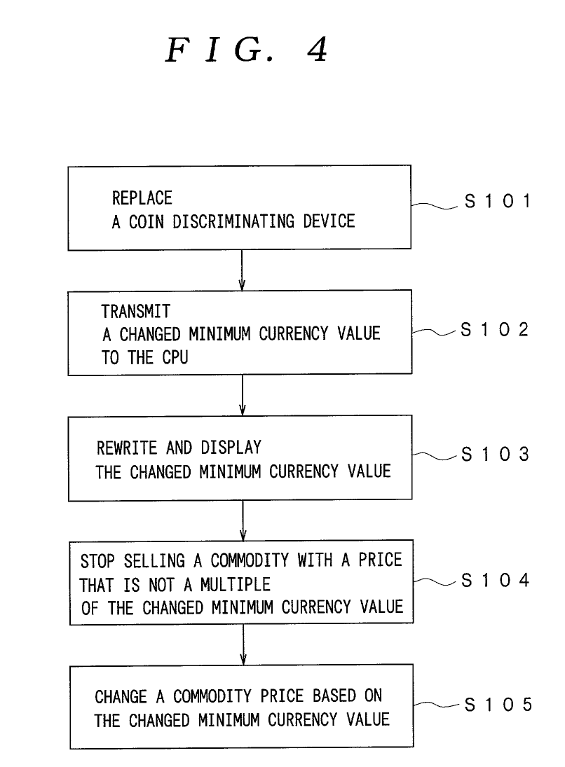

In addition, as shown in FIG. 4, in the case in which the coin discriminating device 21 or the paper currency discriminating device 22 is replaced (S101), which is accompanied by the minimum currency value, a changed minimum currency value (hereinafter referred to as “changed minimum currency value”) is automatically transmitted to the CPU 11 from the coin discrimination device 21 or the like after replacement (S102), and the CPU 11 rewrites this changed minimum currency value data in the storage device 12 and, at the same time, causes the display 40 to display the changed minimum currency value data (S103). In doing so, the CPU 11 automatically stops selling a commodity having a set value that is not a multiple of the changed minimum currency value (S104). In this case, sales of all the commodities may be stopped. Then, the operator forms a numerical value of a changed commodity price based on the changed minimum currency value to be displayed by the display 40 in the inputting apparatus 3, and transfers this numerical value to the storage device 12 via the CPU 11 (S105).

According to the above-mentioned embodiment, since a commodity price is set with a minimum currency value as a minimum unit, a fraction less than the minimum currency value which is not allowed to be used in the automatic vending machine 1 is never set in the commodity price.

Moreover, since a new minimum currency value is displayed on the display 40 as the currency discriminating device 20 is replaced, a commodity price can be surely changed in line with the replacement of the currency discriminating device 20.

What is claimed is:

1. A commodity price setting method in an automatic vending machine, wherein
when a commodity price is inputted in a storage device by an inputting apparatus in said vending machine, said commodity price is formed by multiplying a value of a currency with a minimum amount among currencies that are usable in said vending machine.

2. A commodity price setting system in an automatic vending machine, comprising:
a storage device for storing a commodity price; and
an inputting apparatus for inputting a commodity price in said storage device, wherein
said inputting apparatus forms a commodity price by multiplying a value of a currency with a minimum amount among currencies that are usable in said vending machine.

3. The commodity price setting system in an automatic vending machine according to claim 2, comprising:
a currency discriminating device that can discriminate a type of a usable currency;
a control device for obtaining a minimum currency value from said currency discriminating device and causing said storage device to store the minimum currency value; and
notifying means that can notify an operator of said inputting apparatus of said minimum currency value stored in said storage device.

4. The commodity price setting system in an automatic vending machine according to claim 3, wherein
said notifying means is a display.

5. The commodity price setting system in an automatic vending machine according to claim 3, wherein
said control device updates said minimum currency value stored in said storage device to a changed minimum currency value as said minimum currency value is changed in said currency discriminating device and causes the notifying means to notify the updated minimum currency value.

6. The commodity price setting system in an automatic vending machine according to claim 5, wherein
said control device makes a commodity unavailable for sale, which is not any more a multiple of said updated minimum currency value with a commodity price updated in line with the change of said minimum currency value.
